(19) United States
(12) Patent Application Publication
(10) Pub. No.: US 2023/0155378 A1
(43) Pub. Date: May 18, 2023

(54) RELIABILITY CALCULATION METHOD OF POWER DISTRIBUTION SYSTEM CONSIDERING HIERARCHICAL DECENTRALIZED CONTROL OF DEMAND-SIDE RESOURCES

(71) Applicants: North China Electric Power University, Beijing (CN); State Grid Jibei Electric Power Company Limited, Beijing (CN)

(72) Inventors: Dunnan LIU, Beijing (CN); Heping JIA, Beijing (CN); Xuanyuan WANG, Beijing (CN); Hao ZHANG, Beijing (CN); Zhen LIU, Beijing (CN); Yanbin LI, Beijing (CN); Mingguang LIU, Beijing (CN)

(21) Appl. No.: 17/916,550

(22) PCT Filed: Dec. 23, 2020
(86) PCT No.: PCT/CN2020/138560

§ 371 Date: Sep. 30, 2022

(30) Foreign Application Priority Data
Apr. 8, 2020 (CN) 202010279377.0

(51) Int. Cl. H02J 3/00; G06Q 50/06

(52) U.S. Cl. CPC H02J 3/0012; G06Q 50/06; H02J 2203/20

(57) ABSTRACT

The present invention relates to a reliability calculation method of a power distribution system considering hierarchical decentralized control of demand-side resources, including the following steps: step 1, establishing a multi-state model of wind turbine output and a two-state model of wind turbine failure, which respectively consider randomness of wind speed and uncertainty of wind turbine failure; step 2, establishing a multi-state reliability model of distributed wind power system including a plurality of wind turbines; step 3, establishing a reliability model of information communication system considering hierarchical decentralized control of random failures and information delays; step 4, establishing a reliability model of demand-side resources considering hierarchical decentralized control; and step 5, calculating a value of reliability of a power distribution system considering hierarchical decentralized control of demand-side loads, to acquire an analysis result of the reliability of the power distribution system.

### CROSS-REFERENCE TO RELATED APPLICATIONS

This application is a continuation of International Patent Application No. PCT/CN2020/138560 with a filing date of Dec. 23, 2020, designating the United States, now pending, and further claims priority to Chinese Patent Application No. 202010279377.0 with a filing date of Apr. 8, 2020. The content of the aforementioned applications, including any intervening amendments thereto, are incorporated herein by reference.

### TECHNICAL FIELD

The present invention belongs to the technical field of reliability evaluation of a power system, relates to a reliability calculation method of a power distribution system, and in particular relates to a reliability calculation method of a power distribution system considering hierarchical decentralized control of demand-side resources.

### BACKGROUND OF THE PRESENT INVENTION

The development of distributed generation and demand-side loads in smart grid, such as electric vehicles, air conditioners and other intelligent devices, and the penetration of information and communication technologies provide conditions for demand-side resources including demand-side loads of distributed generators to participate in power system operation. However, if the demand-side resources participate in power grid operation, a series of problems will be brought to the safe and reliable operation of the system. For example, once an information communication system with hierarchical decentralized control fails, demand-side resources in a control region are difficult to participate in demand response, thereby affecting reliability of system operation. Therefore, how to accurately evaluate the influence of hierarchical decentralized control considering information system failure and information delay on participation of the demand-side resources in a power system is very important, and it is urgent to propose an accurate and efficient reliability calculation method.

### SUMMARY OF PRESENT INVENTION

A purpose of the present invention is to overcome shortcomings of the prior art, and provide a reliability calculation method of a power distribution system considering hierarchical decentralized control of demand-side resources, wherein a power distribution system considering hierarchical decentralized control of demand-side resources is taken as an object, and the reliability of the power distribution system considering hierarchical decentralized control of demand-side resources may be accurately calculated with an Lz transformation method.

The present invention solves the practical problems by adopting the following technical solution:

A reliability calculation method of a power distribution system considering hierarchical decentralized control of demand-side resources includes the following steps:

Step 1, establishing a multi-state model of wind turbine output and a two-state model of wind turbine failure, which respectively consider randomness of wind speed and uncertainty of wind turbine failure;

Step 2, establishing a multi-state reliability model of distributed wind power system including a plurality of wind turbines by combining the multi-state model of wind turbine output and the two-state model of wind turbine failure established in step 1;

Step 3, establishing a reliability model of information communication system considering hierarchical decentralized control of random failures and information delays;

Step 4, establishing a reliability model of demand-side resources considering hierarchical decentralized control based on the reliability model of information communication system considering hierarchical decentralized control of random failures and information delays established in step 3;

Step 5, calculating a value of reliability of a power distribution system considering hierarchical decentralized control of demand-side loads according to the multi-state reliability model of distributed wind power system including the plurality of wind turbines established in step 2 and the reliability model of demand-side resources considering hierarchical decentralized control established in step 4, to acquire an analysis result of the reliability of the power distribution system.

In addition, the step 1 specifically includes the following steps:

(1) expressing a relationship between the randomness of wind speed and the wind turbine output by the following formula:

$${PO}_{k} = \{ \begin{matrix}0 , 0 \leq v ( t ) \leq {v}_{ci} \\ {av ( t )}^{2} + bv ( t ) + c , {v}_{ci} \leq v ( t ) \leq {v}_{c} \\ {P}_{k}^{r} , {v}_{c} \leq v ( t ) \leq {v}_{co} \\ 0 , v ( t ) > {v}_{co}\end{matrix}$$

wherein t represents time, and POₖ represents output of a wind turbine k when the wind speed is v(t); v_{ci}, v_{c} and v_{co} respectively represent a cut-in wind speed, a rated wind speed and a cut-out wind speed; Pₖ^{r} represents a rated output of the wind turbine k; parameters a, b and c respectively represent a coefficient of relationship between output of each of the first, second and third wind turbines and the wind speed;

(2) processing, according to the relationship formula between the randomness of wind speed and the wind turbine output, the above formula by Lz transformation to acquire a multi-state model of wind turbine output considering the randomness of wind speed:

$${L}_{k}^{wt} ( z , t ) = {\sum }_{{j}_{k} = 1}^{{J}_{k}} {p}_{{j}_{k}} ( t ) \cdot {z}^{{PO}_{{j}_{k}}}$$

wherein t represents time; Lₖ^{wt} (z,t) represents an Lz transformation expression form of the output of the wind turbine k; jₖ represents an output state of the wind turbine k; the wind turbine k has Jₖ output states in total; pⱼₖ(t) represents a time-varying probability value when the wind turbine k is in an output state jₖ; POⱼₖ represents output of the wind turbine k in a state jₖ; z represents a state value of random variable of wind turbine output; and z^{PO}^{ⱼₖ} represents that a value of wind turbine output is POⱼₖ;

(3) expressing the two-state model of wind turbine failure considering the uncertainty of wind turbine failure as follows:

Lₖ^{r}(z,t)=p^{r}(t)·z^{PO}^{ⱼₖ}+(1−p^{r}(t))·z⁰

wherein Lₖ^{r}(z, t) represents an Lz transformation expression form of failure of the wind turbine k; p^{r} (t) represents an available probability of the wind turbine k, and 0≤p^{r} (t)≤1; when the wind turbine k has a failure, p^{r}(t) is 0; z represents a state value of random variable of wind turbine failure; and z⁰ represents that the wind turbine output is 0 due to the failure of the wind turbine.

In addition, the step 2 specifically includes the following steps:

(1) considering the randomness of wind speed and the wind turbine failure comprehensively, and utilizing a universal generating operator Ωₛ for cascade structure for the multi-state model Lₖ^{wt} (z, t) of wind turbine output with the two-state model Lₖ^{r}(z, t) of wind turbine failure to acquire the multi-state reliability model of wind turbine, which is expressed as Lₖ^{w}(z, t):

$$\begin{matrix}{L}_{k}^{w} ( z , t ) = {Ω}_{s} \{ {L}_{k}^{wt} ( z , t ) , {L}_{k}^{r} ( z , t ) \} \\ = {Ω}_{s} \{ {\sum }_{{j}_{k} = 1}^{{J}_{k}} {p}_{{j}_{k}} ( t ) \cdot {z}^{{PO}_{{j}_{k}}} , {p}^{r} ( t ) \cdot {z}^{{PO}_{{j}_{k}}} + ( 1 - {p}^{r} ( t ) ) \cdot {z}^{0} \} \\ = {\sum }_{{j}_{k} = 1}^{{J}_{k}} {p}_{{j}_{k}} ( t ) \cdot {p}^{r} ( t ) \cdot {z}^{min ( {PO}_{{j}_{k}} , {PO}_{{j}_{k}} )} + {\sum }_{{j}_{k} = 1}^{{J}_{k}} {p}_{{j}_{k}} ( t ) \cdot \\ ( 1 - {p}^{r} ( t ) ) \cdot {z}^{min ( {PO}_{{j}_{k}} , 0 )} \\ = {\sum }_{{j}_{k} = 1}^{{J}_{k}} {p}_{{j}_{k}} ( t ) \cdot {p}^{r} ( t ) \cdot {z}^{{PO}_{{j}_{k}}} + {\sum }_{{j}_{k} = 1}^{{J}_{k}} {p}_{{j}_{k}} ( t ) \cdot ( 1 - {p}^{r} ( t ) ) \cdot {z}^{0} \\ = {\sum }_{{j}_{k} = 1}^{{J}_{k}} {p}_{{j}_{k}} ( t ) \cdot \{ {p}^{r} ( t ) \cdot {z}^{{PO}_{{j}_{k}}} + ( 1 - {p}^{r} ( t ) ) \cdot {z}^{0} \}\end{matrix}$$

(2) utilizing a universal generating operator Ωₚ for cascade structure to acquire a multi-state reliability model of distributed wind power system including K identical wind turbines, which is expressed as L^{wf}(z, t):

$$\begin{matrix}{L}^{wf} ( z , t ) = {Ω}_{p} \{ {L}_{1}^{w} ( z , t ) , ⋯ , {L}_{k}^{w} ( z , t ) , ⋯ , {L}_{K}^{w} ( z , t ) \} \\ = {Ω}_{p} \{ \begin{matrix}{\sum }_{{j}_{1} = 1}^{{J}_{1}} {p}_{{j}_{1}} ( t ) \cdot \{ {p}^{r} ( t ) \cdot {z}^{{PO}_{{j}_{1}}} + ( 1 - {p}^{r} ( t ) ) \cdot {z}^{0} \} , ⋯ , \\ {\sum }_{{j}_{K} = 1}^{{J}_{K}} {p}_{{j}_{K}} ( t ) \cdot \{ {p}^{r} ( t ) \cdot {z}^{{PO}_{{j}_{K}}} + ( 1 - {p}^{r} ( t ) ) \cdot {z}^{0} \}\end{matrix} \} \\ = {\sum }_{{j}_{1} = 1}^{{J}_{1}} ⋯ {\sum }_{{j}_{K} = 1}^{{J}_{K}} {p}_{{j}_{1}} ( t ) {⋯p}_{{j}_{K}} ( t ) \cdot \\ \{ {( t )}^{K} \cdot {z}^{{\sum }_{k = 1}^{K} {PO}_{{j}_{k}}} + ⋯ + {( 1 - {p}^{r} ( t ) )}^{K} \cdot {z}^{0} \} \\ {\sum }_{u = 1}^{U} {P}_{u}^{WF} ( t ) \cdot {z}^{{WF}_{u}}\end{matrix}$$

wherein k represents an ordinal number of a wind turbine; K represents a total number of wind turbines; u represents output states of distributed wind power system, with U states in total; WFᵤ represents output of the distributed wind power system in a state u; pᵤ^{WF} (t) represents a probability when the output of the distributed wind power system is WFᵤ; and z^{WF}^{ᵤ} represents that the value of random variable of distributed wind power system is WFᵤ.

In addition, the step 3 specifically includes the following steps:

(1) considering that a random failure in an information communication system causes invalid control of an i^{th} local controller to an i^{th} demand-side resource region; and meanwhile, considering that a control signal delay causes a response delay Δt^{lc} of demand-side resources, to acquire a reliability model Lᵢ^{lc}(z,t+Δt^{lc}) of the i^{th} demand-side resource region under the circumstances:

Lₜ^{lc}(z,t+Δt^{lc})=Aₜ^{lc}(t)·z¹+[1−Aₜ^{lc}(t)]·z⁰

wherein Δt^{lc} represents delay time of a control signal from the i^{th} local controller to the i^{th} demand-side resource region; Aᵢ^{lc} (t) represents an availability of the information communication system from the i^{th} local controller to the i^{th} demand-side resource region; z represents a state value of random variable of information communication system failure; z¹ represents that a response information communication system works normally; and z⁰ represents a failure of the information communication system;

(2) considering that the random failure in the information communication system causes invalid control of a control center to an i^{th} local controller, to acquire a reliability model Lₜ^{cc} (z,t+Δt^{cc}) of the i^{th} demand-side resource region under the circumstance:

Lᵢ^{cc}(z,t+Δt^{cc})=Aᵢ^{cc}(t)·z¹+[1−Aᵢ^{cc}(t)]·z⁰

wherein Δt^{cc} represents a delay time of a control signal from the control center to the i^{th} local controller; Aᵢ^{cc} (t) represents an availability of the information communication system from the control center to the i^{th} local controller; z represents a state value of random variable; z¹ represents that a response information communication system works normally; and z⁰ represents a failure of the information communication system;

(3) considering the influence of random failure of hierarchical partition control in the information communication system, and utilizing a universal generating operator Ωₛ for cascade structure to acquire a reliability model Lᵢ^{cps} (z,t) of information communication system considering hierarchical decentralized control of random failures and information delays in the i^{th} demand-side resource region:

$$\begin{matrix}{L}_{i}^{cps} ( z , t + Δ {t}^{lc} + Δ {t}^{cc} ) = {Ω}_{s} \{ {L}_{i}^{lc} ( z , t ) , {L}_{i}^{cc} ( z , t ) \} \\ {Ω}_{s} \{ {A}_{i}^{lc} ( t ) \cdot {z}^{1} + [ 1 - {A}_{i}^{lc} ( t ) ] \cdot \\ {z}^{0} , {A}_{i}^{cc} ( t ) \cdot {z}^{2} + [ 1 - {A}_{i}^{cc} ( t ) ] \cdot {z}^{0} \} \\ {A}_{i}^{lc} ( t ) \cdot {A}_{i}^{cc} ( t ) \cdot {z}^{2} + [ 1 - {A}_{i}^{lc} ( t ) \cdot {A}_{i}^{cc} ( t ) ] \cdot {z}^{0}\end{matrix}$$

wherein z represents a state value of random variable of information communication system failure; z¹ represents that a response information communication system works normally; and z⁰ represents a failure of the information communication system.

In addition, the step 4 specifically includes the following steps:

(1) expressing a reliability model Lᵢ^{pl} (z,t) of response quantity of demand-side resources without considering information system failures as:

$${L}_{i}^{pl} ( z , t ) = {\sum }_{{y}_{i} = 1}^{{Y}_{i}} {p}_{{y}_{i}}^{PL} ( t ) \cdot {z}^{{PL}_{{y}_{i}}}$$

wherein t represents time; Lᵢ^{pl} (z,t) represents an Lz transformation expression form of response quantity of a demand-side resource region; z is used for representing a state value of random variable of the response quantity of the demand-side resource region; [symbol] represents that a value of the response quantity of the demand-side resource region of the random variable is PL_{y}_{ᵢ}; PL_{y}_{ᵢ} represents a response quantity of the i^{th} demand-side resource region; yᵢ represents a state of the response quantity of the i^{th} demand-side resource region; the i^{th} demand-side resource region has Yᵢ participation degree states in total; and p_{y}_{ᵢ}^{PL} (t) represents a time-varying probability value when the response quantity of the i^{th} demand-side resource region is in yᵢ;

(2) utilizing the universal generating operator Ωₛ for cascade structure to be combined with the reliability model of information communication system considering hierarchical decentralized control of random failures and information delays in step 3 and the reliability model of response quantity of demand-side resources without considering the information system failures, to acquire a reliability model considering demand-side resource region response quantity, which is expressed as Lᵢ^{ap} (z,t):

$$\begin{matrix}{L}_{i}^{ap} ( z , t ) = {Ω}_{s} \{ {L}_{i}^{pl} ( z , t ) , {L}_{i}^{cps} ( z , t ) \} \\ = {Ω}_{s} \{ {\sum }_{{y}_{i} = 1}^{{Y}_{i}} {p}_{{y}_{i}}^{PL} ( t ) \cdot {z}^{{PL}_{{y}_{i}}} , {A}_{i}^{lc} ( t ) \cdot {A}_{i}^{cc} ( t ) \cdot {z}^{1} + [ 1 - {A}_{i}^{lc} ( t ) \cdot {A}_{i}^{cc} ( t ) ] \cdot \\ \cdot {z}^{0} \} \\ {A}_{i}^{lc} ( t ) \cdot {A}_{i}^{cc} ( t ) \cdot {\sum }_{{y}_{i} = 1}^{{Y}_{i}} {p}_{{y}_{i}}^{PL} ( t ) \cdot {z}^{{PL}_{{y}_{i}}} + \\ [ 1 - {A}_{i}^{lc} ( t ) \cdot {A}_{i}^{cc} ( t ) ] \cdot {\sum }_{{y}_{i} = 1}^{{Y}_{i}} {p}_{{y}_{i}}^{PL} ( t ) \cdot {z}^{0}\end{matrix}$$

wherein t represents time; and Lᵢ^{ap} (z,t) represents an Lz transformation expression form of an actual response quantity of the demand-side resource region;

(3) for N demand-side resource regions in the power distribution system, a reliability model L^{dr} (z,t) of aggregated demand-side resources is expressed as:

$$\begin{matrix}{L}^{dr} ( z , t ) = {Ω}_{p} \{ {L}_{1}^{ap} ( z , t ) , ⋯ , {L}_{i}^{ap} ( z , t ) , ⋯⋯ , {L}_{N}^{ap} ( z , t ) \} \\ = {\sum }_{w = 1}^{W} {p}_{w}^{DR} ( t ) \cdot {z}^{{DR}_{w}}\end{matrix}$$

wherein w represents a state of all demand-side resource regions after aggregation, with W states in total; DR_{w} represents the response quantity provided by all demand-side resource regions in a state w; p_{w}^{DR} (t) represents the probability when the response quantity is DR_{w}; and z^{DR}^{_{w}} represents that a value of the response quantity of the aggregated demand-side resource regions serving as a random variable is DR_{w}.

In addition, the step 5 specifically includes the following steps: acquiring a reliability analysis result of system by the following calculation formula, wherein the reliability analysis result of the power distribution system includes an expected energy not supplied EENS(t) and the system availability AVAI(t):

$$EENS ( t ) = {\sum }_{s ∈ S} {p}_{s} ( t ) \cdot ( L - {WF}_{u} - {DR}_{w} ) \cdot t ( {WF}_{u} + {DR}_{w} < L ) \\ AVAI ( t ) = {\sum }_{s ∈ S} {p}_{s} ( t ) ( {WF}_{u} + {DR}_{w} \geq L )$$

wherein S represents a possible system state set; s is an element in S; L represents the quantity of demand-side resources demanded by the power distribution system; WFᵤ represents an output of the distributed wind power system in a state u in the multi-state reliability model of distributed wind power system; DR_{w} represents a value when a state of the response quantity of demand-side resource region in hierarchical decentralized control is w; pₛ (t) represents a probability when the system state is s, and may be obtained by probability combination; EENS(t) represents an expected energy not supplied of the power distribution system changing with the operation time of the power distribution system; and AVAI(t) represents a system availability changing with the operation time of the system.

The present invention has advantages and beneficial effects as follows:

1. According to the present invention, firstly, a multi-state model of wind turbine output considering randomness of wind speed and a two-state model of wind turbine failure considering uncertainty of wind turbine failure are established, and are combined to establish a multi-state reliability model of distributed wind power system including a plurality of wind turbines; secondly, a reliability model of information communication system in hierarchical decentralized control is established with consideration of random failures and information delays of an information communication system; on this basis, a reliability model of demand-side resources considering hierarchical decentralized control is established; and finally, a reliability index of power distribution system considering hierarchical decentralized control of demand-side loads is calculated to analyze a reliability of the system. According to the present invention, the influence of the information communication system in hierarchical decentralized control on demand-side resources is considered, and reliability of a corresponding power distribution system is analyzed, so that the method provided by the present invention has a certain reference value for construction of a smart grid and provides a scientific basis for better analyzing and evaluating reliability of the smart grid in a novel environment.

2. According to the present invention, a power distribution system considering the hierarchical decentralized control of demand-side resources is taken as an object; an analytical method based on Lz transformation is proposed; a multi-state reliability model of system is established; and the time-varying reliability of the system is quantitatively analyzed, so as to accurately calculate the reliability of the power distribution system considering the hierarchical decentralized control of demand-side resources.

### DESCRIPTION OF THE DRAWINGS

FIG. 1 is a schematic diagram of a hierarchical decentralized control mode of an information communication system according to the present invention;

FIG. 2 is a diagram of a multi-state reliability model of a distributed wind turbine system according to the present invention;

FIG. 3 is a trend diagram of availabilities (AVAI) of a system in different scenes according to embodiments of the present invention; and

FIG. 4 is a diagram of an expected energy not supplied (EENS) of a system in different scenes within a system operation time of 100 hours according to embodiments of the present invention.

### DETAILED DESCRIPTION OF PREFERRED EMBODIMENTS

Embodiments of the present invention will be further described in detail below in combination with the accompanying drawings:

In view of a power distribution system considering hierarchical decentralized control of demand-side resources, the present invention provides a reliability calculation method of a power distribution system considering hierarchical decentralized control of demand-side resources, including the following steps:

Step 1, establishing a multi-state model of wind turbine output and a two-state model of wind turbine failure, which respectively consider randomness of wind speed and uncertainty of wind turbine failure, wherein the step 1 specifically includes the following steps:

(1) expressing a relationship between the randomness of wind speed and the wind turbine output by the following formula:

$${PO}_{k} = \{ \begin{matrix}0 , 0 \leq v ( t ) \leq {v}_{ci} \\ {av ( t )}^{2} + bv ( t ) + c , {v}_{ci} \leq v ( t ) \leq {v}_{c} \\ {P}_{k}^{r} , {v}_{c} \leq v ( t ) \leq {v}_{co} \\ 0 , v ( t ) > {v}_{co}\end{matrix}$$

wherein t represents time, and POₖ represents output of a wind turbine k when the wind speed is v(t); v_{ci}, v_{c} and v_{co} respectively represent a cut-in wind speed, a rated wind speed and a cut-out wind speed; Pₖ^{r} represents a rated output of the wind turbine k; parameters a, b and c respectively represent a coefficient of relationship between output of each of the first, second and third wind turbines and the wind speed;

(2) processing, according to the relationship formula between the randomness of wind speed and the wind turbine output, the above formula by Lz transformation to acquire a multi-state model of wind turbine output considering the randomness of wind speed:

$${L}_{k}^{wt} ( z , t ) = {\sum }_{{j}_{k} = 1}^{{J}_{k}} {p}_{{j}_{k}} ( t ) \cdot {z}^{{PO}_{{j}_{k}}}$$

wherein t represents time; Lₖ^{wt} (z,t) represents an Lz transformation expression form of the output of the wind turbine k; jₖ represents an output state of the wind turbine k; the wind turbine k has Jₖ output states in total; pⱼₖ(t) represents a time-varying probability value when the wind turbine k is in an output state jₖ; POⱼₖ represents output of the wind turbine k in a state jₖ; z represents a state value of random variable of wind turbine output; and [symbol] represents that a value of wind turbine output is POⱼₖ;

(3) expressing the two-state model of wind turbine failure considering the uncertainty of wind turbine failure as follows:

Lₖ^{r}(z,t)=p^{r}(t)· [symbol] +(1−p^{r}(t))·z⁰

wherein L^{r}ₖ(z, t) represents an Lz transformation expression form of failure of the wind turbine k; p^{r} (t) represents an available probability of the wind turbine k, and 0≤p^{r} (t)≤1; when the wind turbine k has a failure, p^{r}(t) is 0; z represents a state value of random variable of wind turbine failure; and z⁰ represents that the wind turbine output is 0 due to the failure of the wind turbine.

Step 2, establishing a multi-state reliability model of distributed wind power system including a plurality of wind turbines by combining the multi-state model of wind turbine output and the two-state model of wind turbine failure established in step 1.

The step 2 specifically includes the following steps:

(1) considering the randomness of wind speed and the wind turbine failure comprehensively, and utilizing a universal generating operator Ωₛ for cascade structure for the multi-state model Lₖ^{wt} (z, t) of wind turbine output with the two-state model Lₖ^{r}(z, t) of wind turbine failure to acquire the multi-state reliability model of wind turbine, which is expressed as Lₖ^{w}(z, t):

$$\begin{matrix}{L}_{k}^{w} ( z , t ) = {Ω}_{s} \{ {L}_{k}^{wt} ( z , t ) , {L}_{k}^{r} ( z , t ) \} = \\ = {Ω}_{s} \{ {\sum }_{{j}_{k} = 1}^{{J}_{k}} {p}_{{j}_{k}} ( t ) \cdot {z}^{{PO}_{{j}_{k}}} , {p}^{r} ( t ) \cdot {z}^{{PO}_{{j}_{k}}} + ( 1 - {p}^{r} ( t ) ) \cdot {z}^{0} \} \\ = {\sum }_{{j}_{k} = 1}^{{J}_{k}} {p}_{{j}_{k}} ( t ) \cdot {p}^{r} ( t ) \cdot {z}^{min ( {PO}_{{j}_{k}} , {PO}_{{j}_{k}} )} + {\sum }_{{j}_{k} = 1}^{{J}_{k}} {p}_{{j}_{k}} ( t ) \cdot ( 1 - {p}^{r} ( t ) ) \cdot \\ {z}^{min ( {PO}_{{j}_{k}} , 0 )} \\ = {\sum }_{{j}_{k} = 1}^{{J}_{k}} {p}_{{j}_{k}} ( t ) \cdot {p}^{r} ( t ) \cdot {z}^{{PO}_{{j}_{k}}} + {\sum }_{{j}_{k} = 1}^{{J}_{k}} {p}_{{j}_{k}} ( t ) \cdot ( 1 - {p}^{r} ( t ) ) \cdot {z}^{0} \\ = {\sum }_{{j}_{k} = 1}^{{J}_{k}} {p}_{{j}_{k}} ( t ) \cdot \{ {p}^{r} ( t ) \cdot {z}^{{PO}_{{j}_{k}}} + ( 1 - {p}^{r} ( t ) ) \cdot {z}^{0} \}\end{matrix}$$

(2) utilizing a universal generating operator Ωₚ for cascade structure to acquire a multi-state reliability model of distributed wind power system including K identical wind turbines, which is expressed as L^{wf}(z, t):

$$\begin{matrix}{L}^{wf} ( z , t ) = {Ω}_{p} \{ {L}_{1}^{w} ( z , t ) , ⋯ , {L}_{k}^{w} ( z , t ) , ⋯ , {L}_{K}^{w} ( x , t ) \} \\ = {Ω}_{p} \{ \begin{matrix}{\sum }_{{j}_{1} = 1}^{{J}_{1}} {p}_{{j}_{1}} ( t ) \cdot \{ {p}^{r} ( t ) \cdot {z}^{{PO}_{{j}_{1}}} + ( 1 - {p}^{r} ( t ) ) \cdot {z}^{0} \} , ⋯ , \\ {\sum }_{{j}_{K} = 1}^{{J}_{K}} {p}_{{j}_{K}} ( t ) \cdot \{ {p}^{r} ( t ) \cdot {z}^{{PO}_{{j}_{K}}} + ( 1 - {p}^{r} ( t ) ) \cdot {z}^{0} \}\end{matrix} \} \\ = {\sum }_{{j}_{1} = 1}^{{J}_{1}} ⋯ {\sum }_{{j}_{K} = 1}^{{J}_{K}} {p}_{{j}_{1}} ( t ) ⋯ {p}_{{j}_{K}} ( t ) \cdot \{ {{p}^{r} ( t )}^{K} \cdot {z}^{{\sum }_{k = 1}^{K} {PO}_{{j}_{K}}} + ⋯ \\ + {( 1 - {p}^{r} ( t ) )}^{K} \cdot {z}^{0} \} \\ = {\sum }_{u = 1}^{U} {p}_{u}^{WF} ( t ) \cdot {z}^{{WF}_{u}}\end{matrix}$$

wherein k represents an ordinal number of a wind turbine; K represents a total number of wind turbines; u represents output states of distributed wind power system, with U states in total; WFᵤ represents output of the distributed wind power system in a state u; pᵤ^{WF}(t) represents a probability when the output of the distributed wind power system is WFᵤ; and z^{WF}^{ᵤ} represents that the value of random variable of distributed wind power system is WFᵤ.

Step 3, establishing a reliability model of information communication system considering hierarchical decentralized control of random failures and information delays;

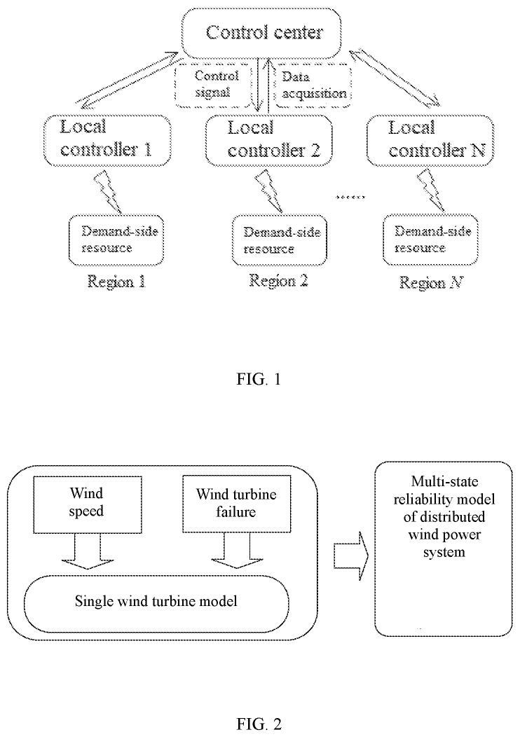

In the present embodiment, firstly, a system model considering hierarchical decentralized control of the information communication system is established, as shown in FIG. 1. The system includes two layers of models; a bottom layer is a control model of a local controller for demand-side resource regions; and an upper layer is a control model of a control center for the local controller. Then, the reliability model of information communication system is acquired by processing in the following manner according to the established system model considering the hierarchical decentralized control of information communication system: Lᵢ^{cps} (z, t).

The step 3 specifically includes the following steps:

(1) considering that a random failure in an information communication system causes invalid control of an i^{th} local controller to an i^{th} demand-side resource region; and meanwhile, considering that a control signal delay causes a response delay Δt^{lc} of demand-side resources, to obtain a reliability model Lᵢ^{lc}(z,t+Δt^{lc}) of the i^{th} demand-side resource region under the circumstances:

Lᵢ^{lc}(z,t+Δt^{lc})=Aᵢ^{lc}(t)·z¹+[1−Aᵢ^{lc}(t)]·z⁰

wherein Δt^{lc} represents delay time of a control signal from the i^{th} local controller to the i^{th} demand-side resource region; Aᵢ^{lc} (t) represents an availability of the information communication system from the i^{th} local controller to the i^{th} demand-side resource region; z represents a state value of random variable of information communication system failure; z¹ represents that a response information communication system works normally; and z⁰ represents a failure of the information communication system;

(2) considering that the random failure in the information communication system causes invalid control of a control center to an i^{th} local controller, to obtain a reliability model Lᵢ^{cc}(z,t+Δt^{cc}) of the i^{th} demand-side resource region under the circumstance:

Lᵢ^{cc}(z,t+Δt^{cc})=Aᵢ^{cc}(t)·z¹+[1−Aᵢ^{cc}(t)]·z⁰

wherein Δt^{cc} represents a delay time of a control signal from the control center to the i^{th} local controller; Aᵢ^{cc} (t) represents an availability of the information communication system from the control center to the i^{th} local controller; z represents a state value of random variable (failure of the information communication system); z¹ represents that a response information communication system works normally; and z⁰ represents a failure of the information communication system;

(3) considering the influence of random failure of hierarchical partition control in the information communication system, and utilizing a universal generating operator Ωₛ for the cascade structure to obtain a reliability model Lᵢ^{cps} (z,t) of information communication system considering hierarchical decentralized control of random failures and information delays in the i^{th} demand-side resource region:

$${L}_{i}^{cps} ( x , t + Δ {t}^{lc} + Δ {t}^{cc} ) = {Ω}_{s} \{ {L}_{i}^{lc} ( z , t ) , {L}_{i}^{cc} ( z , t ) \} = {ω}_{s} \{ {A}_{i}^{lc} ( t ) \cdot {z}^{1} + [ 1 - {A}_{i}^{lc} ( t ) ] \cdot {z}^{0} , {A}_{i}^{cc} ( t ) \cdot {z}^{2} + [ 1 - {A}_{i}^{cc} ( t ) ] \cdot {z}^{0} \} = {A}_{i}^{lc} ( t ) \cdot {A}_{i}^{cc} ( t ) \cdot {z}^{1} + [ 1 - {A}_{i}^{lc} ( t ) \cdot {A}_{i}^{cc} ( t ) ] \cdot {z}^{0}$$

wherein z represents a state value of random variable of information communication system failure; z¹ represents a response information communication system works normally; and z⁰ represents a failure of the information communication system.

Step 4, establishing a reliability model of demand-side resources considering hierarchical decentralized control based on the reliability model of information communication system considering hierarchical decentralized control of random failures and information delays established in step 3;

The step 4 specifically includes the following steps:

(1) expressing a reliability model Lᵢ^{pl} (z,t) of response quantity of demand-side resources without considering information system failures as:

$${L}_{i}^{pl} ( z , t ) = {\sum }_{{y}_{i} = 1}^{{Y}_{i}} {p}_{{y}_{i}}^{PL} ( t ) \cdot {z}^{{PL}_{{y}_{i}}}$$

wherein t represents time; Lᵢ^{pl} (z,t) represents an Lz transformation expression form of response quantity of a demand-side resource region; z is used for representing a state value of random variable of the response quantity of the demand-side resource region; [symbol] represents that a value of the response quantity of the demand-side resource region of the random variable is PL_{y}_{ᵢ}; [symbol] represents a response quantity of the i^{th} demand-side resource region; yᵢ represents a state of the response quantity of the i^{th} demand-side resource region; the i^{th} demand-side resource region has Yᵢ participation degree states in total; and P_{y}_{ᵢ}^{PL}(t) represents a time-varying probability value when the response quantity of the i^{th} demand-side resource region is in yᵢ;

(2) utilizing the universal generating operator Ωₛ for the cascade structure to be combined with the reliability model of information communication system considering hierarchical decentralized control of random failures and information delays in step 3 and the reliability model of response quantity of demand-side resources without considering the information system failure, to obtain a reliability model considering demand-side resource region response quantity, which is expressed as Lᵢ^{ap} (z, t)

$${L}_{i}^{ap} ( z , t ) = {Ω}_{s} \{ {L}_{i}^{pl} ( z , t ) , {L}_{i}^{cps} ( z , t ) \} = {Ω}_{s} \{ {\sum }_{{y}_{i} = 1}^{{Y}_{i}} {p}_{{y}_{i}}^{PL} ( t ) \cdot {z}^{{PL}_{{y}_{i}}} , {A}_{i}^{lc} ( t ) \cdot {A}_{i}^{cc} ( t ) \cdot {z}^{1} + [ 1 - {A}_{i}^{lc} ( t ) \cdot {A}_{i}^{cc} ( t ) ] {z}^{0} \} = {A}_{i}^{lc} ( t ) \cdot {A}_{i}^{cc} ( t ) \cdot {\sum }_{{y}_{i} = 1}^{{Y}_{i}} {p}_{{y}_{i}}^{PL} ( t ) \cdot {z}^{{PL}_{{y}_{i}}} + [ 1 - {A}_{i}^{lc} ( t ) \cdot {A}_{i}^{cc} ( t ) ] \cdot {\sum }_{{y}_{i} = 1}^{{Y}_{i}} {p}_{{y}_{i}}^{PL} ( t ) \cdot {z}^{0}$$

wherein t represents time; and Lᵢ^{ap} (z, t) represents an Lz transformation expression form of an actual response quantity of the demand-side resource region;

(3) for N demand-side resource regions in the power distribution system, a reliability model L^{dr} (z,t) of aggregated demand-side resources is expressed as:

$${L}^{dr} ( z , t ) = {Ω}_{p} \{ {L}_{1}^{ap} ( z , t ) , ⋯ , {L}_{i}^{ap} ( z , t ) , ⋯⋯ , {L}_{N}^{ap} ( z , t ) \} = {\sum }_{w = 1}^{W} {p}_{w}^{DR} ( t ) \cdot {z}^{{DR}_{w}}$$

wherein w represents a state of all demand-side resource regions after aggregation, with W states in total; DR_{w} represents the response quantity provided by all demand-side resource regions in a state w; p_{w}^{DR} (t) represents the probability when the response quantity is DR_{w}; and z^{DR}^{_{w}} represents that a value of the response quantity of the aggregated demand-side resource regions serving as a random variable is DR_{w}.

Step 5, calculating a value of reliability of a power distribution system considering hierarchical decentralized control of demand-side loads according to the multi-state reliability model of distributed wind power system including the plurality of wind turbines established in step 2 and the reliability model of demand-side resources considering hierarchical decentralized control established in step 4, to acquire an analysis result of the reliability of the power distribution system.

In addition, the step 5 specifically includes the following steps: acquiring a reliability analysis result of system by the following calculation formula, wherein the reliability analysis result of the power distribution system includes an expected energy not supplied EENS(t) and the system availability AVAI(t):

$$EENS ( t ) = {\sum }_{s ∈ S} {p}_{s} ( t ) \cdot ( L - {WF}_{u} - {DR}_{w} ) \cdot t ( {WF}_{u} + {DR}_{w} < L ) \\ AVAI ( t ) = {\sum }_{s ∈ S} {p}_{s} ( t ) ( {WF}_{u} + {DR}_{w} \geq L )$$

wherein S represents a possible system state set; s is an element in S; L represents the quantity of demand-side resources demanded by the power distribution system; WFᵤ represents an output of the distributed wind power system in a state u in the multi-state reliability model of distributed wind power system; DR_{w} represents a value when a state of the response quantity of demand-side resource region in hierarchical decentralized control is w; pₛ (t) represents a probability when the system state is s, and may be obtained by probability combination; EENS(t) represents an expected energy not supplied of the power distribution system changing with the operation time of the power distribution system; and AVAI(t) represents a system availability changing with the operation time of the system.

The present invention will be further explained below in combination with specific embodiments:

The power distribution system in the present embodiment includes 10 wind turbines with a rated power of 2 MW, which constitute a distributed power generation subsystem. States of wind speed and states of corresponding wind turbine output, and state transition rates are as shown in Table 1; and the quantity of demand-side resources demanded by the power distribution system is 10 MW. The system includes four demand-side resource regions capable of participating in demand response, having response quantities and state transition rates as shown in Table 2. Average failure time and average maintenance time of the wind turbines and the information communication system are shown in Table 3.

TABLE 1
Wind speed/wind turbine output states and state transition rates

| Transition rate | | 0 MW | 0.5 MW | 1 MW | 1.5 MW | 2 MW |
|---|---|---|---|---|---|---|
| 0 | MW | — | 0.039 | 0.013 | 0.008 | 0.018 |
| 0.5 | MW | 0.365 | — | 0.151 | 0.045 | 0.097 |
| 1 | MW | 0.122 | 0.220 | — | 0.192 | 0.155 |
| 1.5 | MW | 0.038 | 0.093 | 0.185 | — | 0.359 |
| 2 | MW | 0.016 | 0.012 | 0.016 | 0.067 | — |

TABLE 2
Spare capacity and state transition rate of demand-side resources

| Capacity | Transition rate | | |
|---|---|---|---|
| (MW) | 0 | 1 | 2 |
| 0 | — | 0.08 | 0.0133 |
| 1 | 0.0294 | — | 0.3235 |
| 2 | 0.0002 | 0.0001 | — |

TABLE 3
Reliability parameters of wind turbines
and information communication system

| | | Control center - local controller/ |
|---|---|---|
| | | local controller - demand-side |
| Device/parameter | Wind turbine | resource region |
| Failure rate (/hour) | 1/3650 | 1/960 |
| Maintenance rate (/hour) | 1/50 | 1/40 |

In the present embodiment, changes in analysis results of the reliability of the power distribution system in different scenes are analyzed. There are three scenes:

Scene A: delay of information communication system is not considered;

Scene B: a response delay for demand-side resources is 2 hours;

Scene C: a response delay for demand-side resources is 5 hours.

The present embodiment is implemented according to the method described in the summary; and the reliability is specifically analyzed and calculated by the following steps:

1) establishing a multi-state model of wind turbine output considering randomness of wind speed and a two-state model of wind turbine failure considering uncertainty of wind turbine failure;

2) combining the multi-state model of wind turbine output with the two-state model of wind turbine failure to establish a multi-state reliability model of distributed wind power system including a plurality of wind turbines, as shown in FIG. 2;

3) establishing a reliability model of information communication system considering hierarchical decentralized control of random failures and information delays;

4) establishing a reliability model of demand-side resources considering hierarchical decentralized control;

5) calculating a reliability index of power distribution system considering hierarchical decentralized control of demand-side loads.

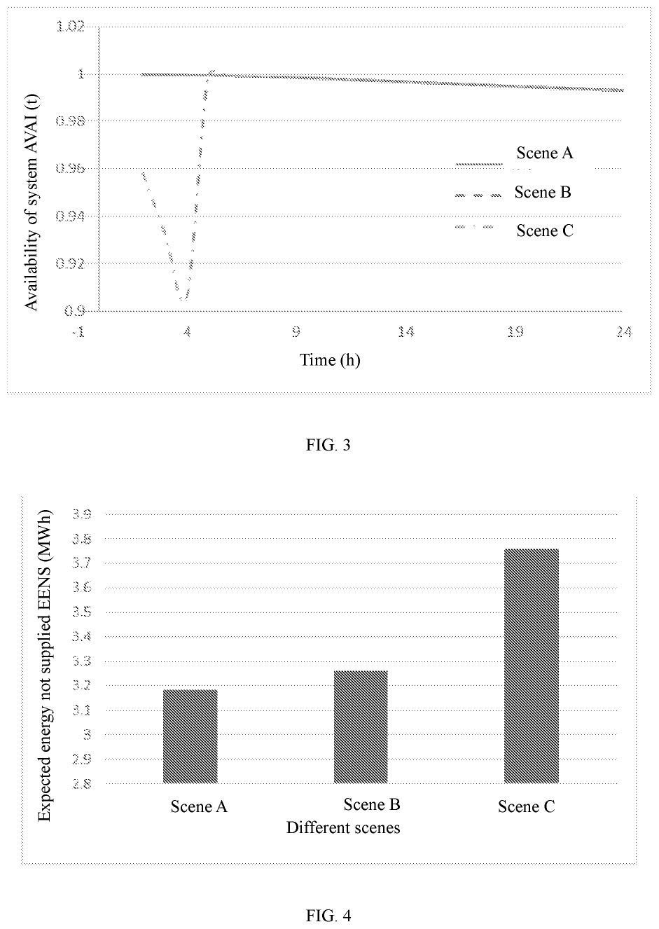

According to the above steps, the reliability analysis results of the system, such as the AVAI and the EENS of the system, at different time points are shown in FIGS. 3 and 4. As shown in FIG. 3, in the scene A that the delay of information communication system is not considered, the AVAI of the system decreases with the increase of system operation time; a comparison result of scenes A, B and C shows that, when the demand-side resources are not put into system operation, the reliability of system is lower than that in the scenes where the demand-side resources are put into system operation, i.e., the delay of information system has influence on the AVAI of the system; and after the demand-side resources are put into system operation, the AVAI of the system suddenly increases. As shown in FIG. 4, when the system operation time is 100 hours, the EENS of a scene with relatively long response delay for demand-side resources is apparently higher than that of a scene with relatively short response delay for demand-side resources; therefore, the information system has an important influence on the reliability of the power distribution system considering the demand-side resources.

The present invention may further improve analysis theory for the reliability of the power system, has important significance for theoretical analysis and engineering application of the power distribution system considering hierarchical decentralized control of demand-side resources, and has certain reference value for engineering construction of the smart grid.

Those skilled in the art shall understand that embodiments of the present application can provide a method, system or computer program product. Therefore, the present application can adopt a form of a full hardware embodiment, a full software embodiment or an embodiment combining software and hardware. Moreover, the present application can adopt a form of a computer program product capable of being implemented on one or more computer available storage media (including but not limited to disk memory, CD-ROM, optical memory, etc.) containing computer available program codes.

The present application is described with reference to flow charts and/or block diagrams according to the method, device (system) and computer program product in the embodiments of the present application. It should be understood that each flow and/or block in the flow charts and/or block diagrams and a combination of flows and/or blocks in the flow charts and/or block diagrams can be realized through computer program instructions. The computer program instructions can be provided for a processor of a general-purpose computer, a special-purpose computer, an embedded processor, or other programmable data processing devices to generate a machine, so that a device for realizing designated functions in one or more flows of the flow charts and/or one or more blocks of the block diagrams is generated through the instructions executed by the processor of the computer or other programmable data processing devices.

The computer program instructions can also be stored in a computer readable memory which can guide the computer or other programmable data processing devices to operate in a special mode, so that the instructions stored in the computer readable memory generate a manufactured product including an instruction device, and the instruction device realizes designated functions in one or more flows of the flow charts and/or one or more blocks of the block diagrams.

The computer program instructions can also be loaded on the computer or other programmable data processing devices, so that a series of operation steps are executed on the computer or other programmable devices to generate processing realized by the computer. Therefore, the instructions executed on the computer or other programmable devices provide steps for realizing designated functions in one or more flows of the flow charts and/or one or more blocks of the block diagrams.

We claim:

1. A reliability calculation method of a power distribution system considering hierarchical decentralized control of demand-side resources, comprising the following steps:
Step 1, establishing a multi-state model of wind turbine output and a two-state model of wind turbine failure, which respectively consider randomness of wind speed and uncertainty of wind turbine failure;
Step 2, establishing a multi-state reliability model of distributed wind power system comprising a plurality of wind turbines by combining the multi-state model of wind turbine output and the two-state model of wind turbine failure established in step 1;
Step 3, establishing a reliability model of information communication system considering hierarchical decentralized control of random failures and information delays;
Step 4, establishing a reliability model of demand-side resources considering hierarchical decentralized control based on the reliability model of information communication system considering hierarchical decentralized control of random failures and information delays established in step 3;
Step 5, calculating a value of reliability of a power distribution system considering hierarchical decentralized control of demand-side loads according to the multi-state reliability model of distributed wind power system comprising the plurality of wind turbines established in step 2 and the reliability model of demand-side resources considering hierarchical decentralized control established in step 4, to acquire an analysis result of the reliability of the power distribution system.

2. The reliability calculation method of the power distribution system considering hierarchical decentralized control of demand-side resources according to claim 1, wherein the step 1 specifically comprises the following steps:
(1) expressing a relationship between the randomness of wind speed and the wind turbine output by the following formula:
$${PO}_{k} = \{ \begin{matrix}0 , 0 \leq v ( t ) \leq {v}_{ci} \\ {av ( t )}^{2} + bv ( t ) + c , {v}_{ci} \leq v ( t ) \leq {v}_{c} \\ {P}_{k}^{r} , {v}_{c} \leq v ( t ) \leq {v}_{co} \\ 0 , v ( t ) > {v}_{co}\end{matrix}$$
wherein t represents time, and POₖ represents output of a wind turbine k when the wind speed is v(t); v_{ci}, v_{c} and v_{co} respectively represent a cut-in wind speed, a rated wind speed and a cut-out wind speed; Pₖ^{r} represents a rated output of the wind turbine k; parameters a, b and c respectively represent a coefficient of relationship between output of each of the first, second and third wind turbines and the wind speed;
(2) processing, according to the relationship formula between the randomness of wind speed and the wind turbine output, the above formula by Lz transformation to acquire a multi-state model of wind turbine output considering the randomness of wind speed:
$${L}_{k}^{wt} ( z , t ) = {\sum }_{{j}_{k} = 1}^{{J}_{k}} {p}_{{j}_{k}} ( t ) \cdot {z}^{{PO}_{{j}_{k}}}$$
wherein t represents time; Lₖ^{wt} (z,t) represents an Lz transformation expression form of the output of the wind turbine k; jₖ represents an output state of the wind turbine k; the wind turbine k has Jₖ output states in total; pⱼₖ(t) represents a time-varying probability value when the wind turbine k is in an output state jₖ; POⱼₖ represents output of the wind turbine k in a state jₖ; z represents a state value of random variable of wind turbine output; and z^{PO}^{ⱼₖ} represents that a value of wind turbine output is POⱼₖ; and
(3) expressing the two-state model of wind turbine failure considering the uncertainty of wind turbine failure as follows:
Lₖ^{r}(z,t)=p^{r}(t)·z^{PO}^{ⱼₖ}+(1−p^{r}(t))·z⁰
wherein Lₖ^{r} (z, t) represents an Lz transformation expression form of failure of the wind turbine k; p^{r} (t) represents an available probability of the wind turbine k, and 0≤p^{r} (t)≤1; when the wind turbine k has a failure, p^{r}(t) is 0; z represents a state value of random variable of wind turbine failure; and z⁰ represents that the wind turbine output is 0 due to the failure of the wind turbine.

3. The reliability calculation method of the power distribution system considering hierarchical decentralized control of demand-side resources according to claim 2, wherein the step 2 specifically comprises the following steps:
(1) considering the randomness of wind speed and the wind turbine failure comprehensively, and utilizing a universal generating operator Ωₛ for cascade structure for the multi-state model Lₖ^{wt} (z, t) of wind turbine output with the two-state model Lₖ^{r}(z, t) of wind turbine failure to acquire the multi-state reliability model of wind turbine, which is expressed as Lₖ^{w}(z, t):
$$\begin{matrix}{L}_{k}^{w} ( z , t ) = {Ω}_{s} \{ {L}_{k}^{wt} ( z , t ) , {L}_{k}^{r} ( z , t ) \} \\ = {Ω}_{s} \{ {\sum }_{{j}_{k} = 1}^{{J}_{k}} {p}_{{j}_{k}} ( t ) \cdot {z}^{{PO}_{{j}_{k}}} , {p}^{r} ( t ) \cdot {z}^{{PO}_{{j}_{k}}} + ( 1 - {p}^{r} ( t ) ) \cdot {z}^{0} \} \\ = {\sum }_{{j}_{k} = 1}^{{J}_{k}} {p}_{{j}_{k}} ( t ) \cdot {p}^{r} ( t ) \cdot {z}^{min ( {PO}_{{j}_{k}} , {PO}_{{j}_{k}} )} + \\ = {\sum }_{{j}_{k} = 1}^{{J}_{k}} {p}_{{j}_{k}} ( t ) \cdot ( 1 - {p}^{r} ( t ) ) \cdot {z}^{min ( {PO}_{{j}_{k}} , 0 )} \\ = {\sum }_{{j}_{k} = 1}^{{J}_{k}} {p}_{{j}_{k}} ( t ) \cdot {p}^{r} ( t ) \cdot {z}^{{PO}_{{j}_{k}}} + {\sum }_{{j}_{k} = 1}^{{J}_{k}} {p}_{{j}_{k}} ( t ) \cdot ( 1 - {p}^{r} ( t ) ) \cdot {z}^{0} \\ = {\sum }_{{j}_{k} = 1}^{{J}_{k}} {p}_{{j}_{k}} ( t ) \cdot \{ {p}^{r} ( t ) \cdot {z}^{{PO}_{{j}_{k}}} + ( 1 - {p}^{r} ( t ) ) \cdot {z}^{0} \}\end{matrix}$$
(2) utilizing a universal generating operator Ωₚ for cascade structure to acquire a multi-state reliability model of distributed wind power system comprising K identical wind turbines, which is expressed as L^{wf}(z, t):
$$\begin{matrix}{L}^{wf} ( z , t ) = {Ω}_{p} \{ {L}_{1}^{w} ( z , t ) , ⋯ , {L}_{k}^{w} ( z , t ) , ⋯ , {L}_{K}^{w} ( x , t ) \} \\ = {Ω}_{p} \{ \begin{matrix}{\sum }_{{j}_{1} = 1}^{{J}_{1}} {p}_{{j}_{1}} ( t ) \cdot \{ {p}^{r} ( t ) \cdot {z}^{{PO}_{{j}_{1}}} + ( 1 - {p}^{r} ( t ) ) \cdot {z}^{0} \} , ⋯ , \\ {\sum }_{{j}_{K} = 1}^{{J}_{K}} {p}_{{j}_{K}} ( t ) \cdot \{ {p}^{r} ( t ) \cdot {z}^{{PO}_{{j}_{K}}} + ( 1 - {p}^{r} ( t ) ) \cdot {z}^{0} \}\end{matrix} \} \\ = {\sum }_{{j}_{1} = 1}^{{J}_{1}} ⋯ {\sum }_{{j}_{K} = 1}^{{J}_{K}} {p}_{{j}_{1}} ( t ) ⋯ {p}_{{j}_{K}} ( t ) \cdot \{ {{p}^{r} ( t )}^{K} \cdot {z}^{{\sum }_{k = 1}^{K} {PO}_{{j}_{K}}} + ⋯ + \\ {( 1 - {p}^{r} ( t ) )}^{K} \cdot {z}^{0} \} \\ = {\sum }_{u = 1}^{U} {p}_{u}^{WF} ( t ) \cdot {z}^{{WF}_{u}}\end{matrix}$$
wherein k represents an ordinal number of a wind turbine; K represents a total number of wind turbines; u represents output states of distributed wind power system; WFᵤ represents output of the distributed wind power system in a state u; pᵤ^{WF} (t) represents a probability when the output of the distributed wind power system is WFᵤ; and z^{WF}^{ᵤ} represents that the value of random variable of distributed wind power system is WFᵤ.

4. The reliability calculation method of the power distribution system considering hierarchical decentralized control of demand-side resources according to claim 1, wherein the step 3 specifically comprises the following steps:
(1) considering that a random failure in an information communication system causes invalid control of an i^{th} local controller to an i^{th} demand-side resource region; and meanwhile, considering that a control signal delay causes a response delay Δt^{lc} of demand-side resources, to acquire a reliability model Lᵢ^{lc}(z, t+Δt^{lc}) of the i^{th} demand-side resource region under the circumstances:
Lᵢl^{c}(z,t+Δt^{lc})=Aᵢ^{lc}(t)·z¹+[1−Aᵢ^{lc}(t)]·z⁰
wherein Δt^{lc} represents delay time of a control signal from the i^{th} local controller to the i^{th} demand-side resource region; Aᵢ^{lc} (t) represents an availability of the information communication system from the i^{th} local controller to the i^{th} demand-side resource region; z represents a state value of random variable of information communication system failure; z¹ represents that a response information communication system works normally; and z⁰ represents a failure of the information communication system;
(2) considering that the random failure in the information communication system causes invalid control of a control center to an i^{th} local controller, to acquire a reliability model Lᵢ^{cc} (z,t+Δt^{cc}) of the i^{th} demand-side resource region under the circumstance:
Lᵢ^{cc}(z,t+Δt^{cc})=Aᵢ^{cc}(t)·z¹+[1−Aᵢ^{cc}(t)]·z⁰
wherein Δt^{cc} represents a delay time of a control signal from the control center to the i^{th} local controller; Aᵢ^{cc}(t) represents an availability of the information communication system from the control center to the i^{th} local controller; z represents a state value of random variable; z¹ represents that a response information communication system works normally; and z⁰ represents a failure of the information communication system;
(3) considering the influence of random failure of hierarchical partition control in the information communication system, and utilizing a universal generating operator Ωₛ for cascade structure to acquire a reliability model Lᵢ^{cps} (z,t) of information communication system considering hierarchical decentralized control of random failures and information delays in the i^{th} demand-side resource region:
$${L}_{i}^{cps} ( x , t + Δ {t}^{lc} + Δ {t}^{cc} ) = {Ω}_{s} \{ {L}_{i}^{lc} ( z , t ) , {L}_{i}^{cc} ( z , t ) \} = {ω}_{s} \{ {A}_{i}^{lc} ( t ) \cdot {z}^{1} + [ 1 - {A}_{i}^{lc} ( t ) ] \cdot {z}^{0} , {A}_{i}^{cc} ( t ) \cdot {z}^{2} + [ 1 - {A}_{i}^{cc} ( t ) ] \cdot {z}^{0} \} = {A}_{i}^{lc} ( t ) \cdot {A}_{i}^{cc} ( t ) \cdot {z}^{1} + [ 1 - {A}_{i}^{lc} ( t ) \cdot {A}_{i}^{cc} ( t ) ] \cdot {z}^{0}$$
wherein z represents a state value of random variable of information communication system failure; z¹ represents that a response information communication system works normally; and z⁰ represents a failure of the information communication system.

5. The reliability calculation method of the power distribution system considering hierarchical decentralized control of demand-side resources according to claim 4, wherein the step 4 specifically comprises the following steps:
(1) expressing a reliability model Lᵢ^{pl} (z,t) of response quantity of demand-side resources without considering information system failures as:
$${L}_{i}^{pl} ( z , t ) = {\sum }_{{y}_{i} = 1}^{{Y}_{i}} {p}_{{y}_{i}}^{PL} ( t ) \cdot {z}^{{PL}_{{y}_{i}}}$$
wherein t represents time; Lᵢ^{pl} (z, t) represents an Lz transformation expression form of response quantity of a demand-side resource region; z is used for representing a state value of random variable of the response quantity of the demand-side resource region; [symbol] represents that a value of the response quantity of the demand-side resource region of the random variable is PL_{y}_{ᵢ}; PL_{y}_{ᵢ} represents a response quantity of the i^{th} demand-side resource region; yᵢ represents a state of the response quantity of the i^{th} demand-side resource region; the i^{th} demand-side resource region has Yᵢ participation degree states in total; and p_{y}_{ᵢ}^{PL} (t) represents a time-varying probability value when the response quantity of the i^{th} demand-side resource region is in yᵢ;
(2) utilizing the universal generating operator Ωₛ for cascade structure to be combined with the reliability model of information communication system considering hierarchical decentralized control of random failures and information delays in step 3 and the reliability model of response quantity of demand-side resources without considering the information system failures, to acquire a reliability model considering demand-side resource region response quantity, which is expressed as Lᵢ^{ap} (z,t)
$${L}_{i}^{ap} ( z , t ) = {Ω}_{s} \{ {L}_{i}^{pl} ( z , t ) , {L}_{i}^{cps} ( z , t ) \} = {Ω}_{s} \{ {\sum }_{{y}_{i} = 1}^{{Y}_{i}} {p}_{{y}_{i}}^{PL} ( t ) \cdot {z}^{{PL}_{{y}_{i}}} , {A}_{i}^{lc} ( t ) \cdot {A}_{i}^{cc} ( t ) \cdot {z}^{1} + [ 1 - {A}_{i}^{lc} ( t ) \cdot {A}_{i}^{cc} ( t ) ] {z}^{0} \} = {A}_{i}^{lc} ( t ) \cdot {A}_{i}^{cc} ( t ) \cdot {\sum }_{{y}_{i} = 1}^{{Y}_{i}} {p}_{{y}_{i}}^{PL} ( t ) \cdot {z}^{{PL}_{{y}_{i}}} + [ 1 - {A}_{i}^{lc} ( t ) \cdot {A}_{i}^{cc} ( t ) ] \cdot {\sum }_{{y}_{i} = 1}^{{Y}_{i}} {p}_{{y}_{i}}^{PL} ( t ) \cdot {z}^{0}$$
wherein t represents time; and Lᵢ^{ap} (z, t) represents an Lz transformation expression form of an actual response quantity of the demand-side resource region;
(3) for N demand-side resource regions in the power distribution system, a reliability model L^{dr} (z, t) of aggregated demand-side resources is expressed as:
$${L}^{dr} ( z , t ) = {Ω}_{p} \{ {L}_{1}^{ap} ( z , t ) , ⋯ , {L}_{i}^{ap} ( z , t ) , ⋯⋯ , {L}_{N}^{ap} ( z , t ) \} = {\sum }_{w = 1}^{W} {p}_{w}^{DR} ( t ) \cdot {z}^{{DR}_{w}}$$
wherein w represents a state of all demand-side resource regions after aggregation, with W states in total; DR_{w} represents the response quantity provided by all demand-side resource regions in a state w; p_{w}^{DR} (t) represents the probability when the response quantity is DR_{w}; and z^{DR}^{_{w}} represents that a value of the response quantity of the aggregated demand-side resource regions serving as a random variable is DR_{w}.

6. The reliability calculation method of the power distribution system considering hierarchical decentralized control of demand-side resources according to claim 1, wherein the step 5 specifically comprises the following steps: acquiring a reliability analysis result of system by the following calculation formula, wherein the reliability analysis result of the power distribution system comprises an expected energy not supplied EENS(t) and the system availability AVAI(t):
$$EENS ( t ) = {\sum }_{s ∈ S} {p}_{s} ( t ) \cdot ( L - {WF}_{u} - {DR}_{w} ) \cdot t ( {WF}_{u} + {DR}_{w} < L ) \\ AVAI ( t ) = {\sum }_{s ∈ S} {p}_{s} ( t ) ( {WF}_{u} + {DR}_{w} \geq L )$$
wherein S represents a possible system state set; s is an element in S; L represents the quantity of demand-side resources demanded by the power distribution system; WFᵤ represents an output of the distributed wind power system in a state u in the multi-state reliability model of distributed wind power system; DR_{w} represents a value when a state of the response quantity of demand-side resource region in hierarchical decentralized control is w; pₛ (t) represents a probability when the system state is s, and may be obtained by probability combination; EENS(t) represents an expected energy not supplied of the power distribution system changing with the operation time of the power distribution system; and AVAI(t) represents a system availability changing with the operation time of the system.
